(19) United States
(12) Patent Application Publication
(10) Pub. No.: US 2021/0347646 A1
(43) Pub. Date: Nov. 11, 2021

(54) Melanized Aerogel

(71) Applicants: Gabrielle Sabrina Rey, Maple Heights, OH (US); Saranshu Singla, Akron, OH (US); Ali Dhinojwala, Akron, OH (US); Stephanie Vivod, Euclid, OH (US)

(72) Inventors: Gabrielle Sabrina Rey, Maple Heights, OH (US); Saranshu Singla, Akron, OH (US); Ali Dhinojwala, Akron, OH (US); Stephanie Vivod, Euclid, OH (US)

(21) Appl. No.: 17/025,153

(22) Filed: Sep. 18, 2020

Related U.S. Application Data
(60) Provisional application No. 62/936,768, filed on Nov. 18, 2019.
(60) Provisional application No. 62/948,925, filed on Dec. 17, 2019.

(51) Int. Cl. C01B 33/159; C01B 33/155; C01B 33/158

(52) U.S. Cl. CPC C01B 33/159; C01B 33/1585; C01B 33/155

(57) ABSTRACT

A process of preparing a polydopamine aerogel comprising first mixing together a silica precursor and an amine-functionalized silica precursor in a solvent to form a first solution. Then, adding an acid catalyst to the first solution to form a silica gel. Then, equilibrating the silica gel in a 50/50 solvent/water mixture. Wherein the final step in the process is to add about 1 mg/ml solution of a dopamine monomer to the silica gel to form a polydopamine aerogel.

### CROSS-REFERENCE TO RELATED APPLICATIONS

The present application claims the benefit of U.S. Provisional Patent Application No. 62/936,768, filed on Nov. 18, 2019 and U.S. Provisional Patent Application No. 62/948,925, filed on Dec. 17, 2019, which are each incorporated herein in their entirety.

### STATEMENT REGARDING FEDERALLY SPONSORED RESEARCH OR DEVELOPMENT

This invention was made with government support under FA-9550-18-1-0142 awarded by Air Force Office of Scientific Research. The government has certain rights in the invention.

### FIELD OF THE INVENTION

The present invention generally relates to aerogels and methods of creating the same. Particularly, the present invention relates to silica aerogels and methods of creating the same. More particularly, the present invention relates to polydopamine-coated silica aerogels having enhanced UV-absorption as compared to native silica aerogels.

### BACKGROUND OF THE INVENTION

Creating a melanized, high surface area material can be advantageous for applications of radiation mitigation, catalysis, and filtration. For these reasons, functionalizing an aerogel with polydopamine is of great interest. Aerogels of various materials, such as chitosan, cellulose, and melamine-formaldehyde have been functionalized with polydopamine. In the past, polydopamine functionalized aerogels have been used for adsorption application, catalysis applications, and as a coating on metal organic frameworks in order to obtain a melanized high surface area material. However, all these past uses of polydopamine functionalized aerogels have synthetized the polydopamine prior to incorporating it into the aerogel matrix, and in most instances, the polymerization of the dopamine had to utilize the addition of a harsh base.

Polydopamine is a bioinspired-polymeric coating that has gained significant attention within the past decade due to its excellent properties including biocompatibility, biodegradability, radical quenching ability, and its adhesive nature. Polydopamine is considered as a synthetic form of the biological pigment eumelanin because it exhibits many similar properties. Polydopamine has a broad absorption spectrum ranging from the ultraviolet (UV) range to the infrared range, which makes it a great photoprotector. Further, the free radical character of polydopamine makes it behave as a great free radical quencher. Polydopamine is also structurally similar to eumelanin, which makes it a thermally stable polymer. Although such characteristics of polydopamine have been noted, the mechanism of its formation and the structure thus formed is still unclear in literature.

Silica aerogels are lightweight, open-celled porous structures with added characteristics of low density, nano-scale porosity, and a high surface area. Silica aerogels are formed by the condensation and hydrolysis reactions between silicon alkoxides via a known sol-gel synthesis. This reaction will yield a network of SiO2 particles in the form of a hydrogel. Removal of the solvent portion of the gel utilizing supercritical fluid extraction will yield an aerogel without compromising the three-dimensional structure of the aerogel. The high surface area of these aerogels (350-1,200 m2/g), low density (0.12 g/cc), and nano-porosity (>90% with pore sizes ranging from 15-40 nm) make them ideal for a variety of aerospace, aeronautical, and other commercial applications.

To add desirable traits to silica aerogels, functionalizing the silica particles of the aerogels have been utilized to create mechanically robust aerogels. Additionally, the pendant groups on the backbone have been utilized for adsorption and purification applications. Typically, aerogels are known to be good insulators due to their highly porous structure.

However, by introducing dopants into the mesoporous structure of silica aerogels, thermally conductive aerogels can be created.

There has been recent interest in functionalizing aerogels using simple coating methods to deposit polydopamine. However, all previous attempts have had to utilize the addition of a base. The typical base that has been used to synthesize polydopamine is tris(hydroxymethyl)aminomethane, also known simply as tris. For example, previous attempts have used tris to synthesize a polydopamine suspension prior to incorporating the polydopamine into the aerogel matrix. Others have mixed graphene oxide powder with tris so that dopamine can polymerize into a polydopamine coating around the graphene oxide powder. Then, chitosan was introduced into the polydopamine coated graphene oxide powder in order to obtain a polydopamine functionalized chitosan. Yet others have allowed dopamine to polymerize into a polydopamine coating around cellulose nanofibrils that were then integrated into a wet gel matrix in order to obtain a polydopamine functionalized aerogel.

Although tris is a relatively mild base, others have also attempted to utilize harsher bases in order to create polydopamine suspensions. For example, some have exposed a cellulose aerogel to gaseous ammonia in order to create active sites on the aerogel for the polymerization of dopamine. And yet others have added a solution of chitosan and dopamine at a constant rate to sodium hydroxide in order to obtain a polydopamine functionalized chitosan aerogel. Thus, there is a need in the art for a more effective process wherein the aid of an external base is not needed

### SUMMARY OF THE INVENTION

In one embodiment, the present invention provides a process of coating a silica aerogel with polydopamine comprising: a) mixing together a silica precursor and an amine-functionalized silica precursor in a solvent to form a first solution; b) adding an acid catalyst to the first solution to form a silica gel; c) equilibrating the silica gel in a 50/50 solvent/water mixture; and d) adding between a 1 mg/mL and 2 mg/mL solution of a dopamine monomer to the silica gel to form a polydopamine coated aerogel.

In a second embodiment, the present invention provides a process as in the above embodiment wherein the silica precursor is selected from tetramethyl orthosilicate (TMOS) or tetraethyl orthosilicate (TEOS).

In a third embodiment, the present invention provides a process as in the above embodiments wherein the amine-functionalized silica precursor is (3-Aminopropyl)triethoxysilane (APTES) or (3-Aminopropyl)trimethoxysilane (APTMS).

In a fourth embodiment, the present invention provides a process as in the above embodiments wherein the solvent is selected from ethanol or methanol.

In a fifth embodiment, the present invention provides a process as in the above embodiments wherein the acid catalyst is selected from the group consisting of hydrochloric acid, nitric acid, sulfuric acid, oxalic acid, hydrofluoric acid, acetic acid, or water.

In a sixth embodiment, the present invention provides a process as in the above embodiments wherein the dopamine monomer is selected from the group consisting of dopamine hydrochloride, levodopa (L-DOPA), catechol, tyrosine, leucodopachrome, adrenochrome, 1,8-dihydroxynaphthalene, 5,6-dihydroxyindole-2-carboxylic acid (DHICA), 5,6-dihydroxyindole (DHI), epinephrine, norepinephrine, serotonin, tryptamine, tyramine, cysteine, selenocysteine, glutamine hydroxamate (HGA), or 5-cys-dopa.

In a seventh embodiment, the present invention provides a process as in the above embodiments wherein the silica precursor is TMOS, the amine-functionalized silica precursor is APTES, the solvent is ethanol, the acid catalyst is water, and the dopamine monomer is dopamine hydrochloride.

In an eighth embodiment, the present invention provides a process as in the above embodiments wherein the process further comprises the step of washing the silica gel with the solvent prior to step c).

In a ninth embodiment, the present invention provides a process as in the above embodiments wherein the process further comprises the step of equilibrating the polydopamine aerogel formed in step d) in a 100% solvent solution.

In a tenth embodiment, the present invention provides a polydopamine coated silica aerogel comprising the reaction product of a silica gel and a dopamine monomer solution, wherein the silica gel comprises the reaction product of a silica precursor, an amine-functionalized silica precursor, and an acid catalyst.

In an eleventh embodiment, the present invention provides a polydopamine coated silica aerogel as above wherein the silica precursor is tetramethyl orthosilicate (TMOS) or tetraethyl orthosilicate (TEOS).

In a twelfth embodiment, the present invention provides a polydopamine coated silica aerogel as any of the above wherein the amine-functionalized silica precursor is (3-Aminopropyl)triethoxysilane (APTES) or (3-Aminopropyl)trimethoxysilane (APTMS).

In a thirteenth embodiment, the present invention provides a polydopamine coated silica aerogel as any of the above wherein the acid catalyst is selected from the group consisting of hydrochloric acid, nitric acid, sulfuric acid, oxalic acid, hydrofluoric acid, acetic acid, or water.

In a fourteenth embodiment, the present invention provides a polydopamine coated silica aerogel as any of the above wherein the dopamine monomer is selected from the group consisting of dopamine hydrochloride, levodopa (L-DOPA), catechol, tyrosine, leucodopachrome, adrenochrome, 1,8-dihydroxynaphthalene, 5,6-dihydroxyindole-2-carboxylic acid (DHICA), 5,6-dihydroxyindole (DHI), epinephrine, norepinephrine, serotonin, tryptamine, tyramine, cysteine, selenocysteine, glutamine hydroxamate (HGA), or 5-cys-dopa.

In a fifteenth embodiment, the present invention provides a polydopamine coated silica aerogel as any of the above wherein silica the precursor is TMOS, the amine-functionalized silica precursor is APTES, the solvent is ethanol, the acid catalyst is water, and the dopamine monomer is dopamine hydrochloride

### DETAILED DESCRIPTION OF ILLUSTRATIVE EMBODIMENTS

Embodiments of the present invention are based, at least in part, on polydopamine-coated silica aerogels with enhanced UV-absorption and methods of making the same. The polydopamine-coated silica aerogels of the present invention offer similar surface area and porosity measurements as compared to native silica aerogels, while at the same time offering the ability to better absorb UV light as compared to native silica aerogels. Therefore, the polydopamine-coated silica aerogels of the present invention are unique materials that can serve as radiation mitigating materials due to their high surface area, low density, and their strong absorption of UV light.

To prepare the polydopamine-coated silica aerogels of the present invention, silica gels must first be prepared. In one or more embodiments, silica aerogels are prepared using the traditional sol-gel process for producing solid materials from small molecules. The sol-gel process involves the conversion of monomers into a colloidal solution (sol) that acts as the precursor for an integrated network (gel) of network polymers.

First, a silica precursor and an amine-functionalized silica precursor are mixed in a solvent to form a first solution, and an acid catalyst is added to the first solution to form a silica gel. The concentration of the first solution is between 1.00 mol/L and 1.50 mol/L, in other embodiments between 1.10 mol/L and 1.40 mol/L, and in yet other embodiments between 1.20 mol/L and 1.30 mol/L. In some embodiments, the concentration of the first solution is 1.25 mol/L. The acid catalyst concentration is between 8 v/v % and 14 v/v %, in other embodiments between 9 v/v % and 13 v/v %, and in yet other embodiments between 10 v/v % and 12 v/v %. In some embodiments, the acid catalyst concentration is 11 v/v %. The silica precursor, the amine-functionalized silica precursor and the acid catalyst are swirled vigorously for a few seconds at room temperature and the first solution is then poured into desired molds to form the gel.

In some embodiments the silica precursor is selected from tetramethyl orthosilicate (TMOS, 14 v/v %) or tetraethyl orthosilicate (TEOS, 14 v/v %).

In some embodiments, the amine-functionalized silica precursor is selected from (3-Aminopropyl)triethoxysilane (APTES, 7.34 v/v %) or (3-Aminopropyl)trimethoxysilane (APTMS, 7.34 v/v %).

In some embodiments, the solvent is selected from ethanol or methanol.

The acid catalyst such one selected from the group consisting of hydrochloric acid, nitric acid, sulfuric acid, oxalic acid, hydrofluoric acid, acetic acid, or water. An acid catalyst is defined as any compound that has a pH of between 1 and 7.

The first solution with added acid catalyst is swirled vigorously, poured into cylindrical molds, and left to age for at least 24 hours. The formed silica gels are then washed four times over the course of 24 hours, typically with whichever solvent was selected above, either ethanol or methanol, to remove any impurities and unreacted monomers from the gels.

Next, the fully formed gels are slowly moved into a 100% solvent solution, wherein the solvent is whichever solvent was selected above, either ethanol or methanol. The silica gel is then equilibrated in a 50/50 solvent/water solution, wherein the solvent is the same as selected in the previous step. The concentration of the water in the solution is slowly increased to prevent the collapse of the porous structure of the silica gels.

Once the gels have equilibrated in the 50/50 solvent/water solution, a solution of dopamine monomer in a solvent is added to the silica gel to form a polydopamine aerogel. The concentration of the dopamine monomer is between 0.01 and 4.00 mg/ml, in other embodiments between 0.05 and 3.00 mg/ml, and in yet other embodiments between 1.00 and 2.00 mg/ml. To create the dopamine monomer solution, dopamine monomer is first dissolved in 50 mL of water, and then a solvent, either ethanol or methanol, is added. Finally, this dopamine monomer in a solution is added to the 50/50 solvent/water solution that includes the silica gel.

The dopamine monomer is a derivative of the naturally occurring amino acid tyrosine, which is a precursor to melanin. In some embodiments, the dopamine monomer is selected from the group consisting of dopamine hydrochloride, levodopa (L-DOPA), catechol, tyrosine, leucodopachrome, adrenochrome, 1,8-dihydroxynaphthalene, 5,6-dihydroxyindole-2-carboxylic acid (DHICA), 5,6-dihydroxyindole (DHI), epinephrine, norepinephrine, serotonin, tryptamine, tyramine, cysteine, selenocysteine, glutamine hydroxamate (HGA), or 5-cys-dopa is added to the mixture.

The dopamine monomer slowly diffuses through the pores of the gel and starts to polymerize on the surface of the gel after about 10 minutes.

Once the polymerization of the dopamine monomer occurs, a brownish coating forms on the exterior of and on the interior of the gel. Once the entirety of the gel has a light brown tint, the polymerization is slowly quenched by performing a solvent exchange of the water with solvent to again avoid the collapse of the porous structure of the gel. The coated silica gel will go through a series of solvent exchanges wherein the coated gel is placed in different solvents in order to place the coated gel into a 100$ solvent solution, wherein the solvent is either ethanol or methanol. In one or more embodiments, the solvent exchanges will be 70%/30% solvent/water, then 90%/10% solvent/water, and finally 100% solvent. During each exchange, the coated gel will sit in each solvent exchange for about 20 minutes.

Once the coated gels are equilibrated in a 100% solvent solution, they are allowed to sit for a period of between 4 and 24 hours to extract any unreacted monomers and to remove any impurities. The final step in the process is to have the aerogel undergo supercritical drying using CO₂.

In one embodiment, the silica precursor is TMOS, the amine-functionalized silica precursor is APTES, the solvent is ethanol, the acid catalyst is water, and the dopamine monomer is dopamine hydrochloride.

Various silica aerogels were coated with polydopamine utilizing the process as described above over different time periods (t=0, 1, 2, 3, 7, 12, 21, and 24 hours). To understand how the polydopamine coating affects the characteristics of the silica aerogels, the aerogels obtained at t=0 (native silica aerogel), t=12 h, and t=24 h, were characterized. A pearl necklace morphology was seen in the native silica aerogel, which was created by the secondary particles. The average diameter of the secondary particle was determined to be 24±5 nm as based on SEM images. The pore sizes were also determined using SEM images, which revealed an average pore size of the native silica aerogel to be 45.7±31.4 nm. The morphology of the polydopamine-coated aerogels at t=12 and t=24 h were similar to those of the native silica aerogel, which indicates no change in the pearl necklace morphology and the structure of aerogels after coating. The secondary particle size for the coated aerogels at t=12 h was 23±5 nm and the secondary particle size for the coated aerogels at t=24 h was 23±4 nm, which again, were similar to that values as determined for the native aerogels. The aerogels coated for t=12 h and t=24 h showed an average pore size of 36.7±13.4 nm and 51.8±13.3 nm, respectively.

Using the Games-Howell test, no statistical differences in pore sizes between the 0 h and 12 h coated aerogels (p=0.54), similarly there was no statistical differences in pore sizes found between the 0 h and 24 h coated aerogels (p=0.23). Although a statistical difference was found in the pore sizes of 12 h coated and 24 h coated aerogels (p=0.01), the statistical difference fell within acceptable ranges. Thus, all the aerogel samples maintained a mesoporous structure even after coating with polydopamine.

Low density and high porosity are common characteristics of most aerogels. Bulk densities for the native silica aerogels and the polydopamine-coated aerogels at a coating time of 12 hours and 24 hours, were recorded. The bulk density of the native silica aerogel was 0.14 g/cm³, the silica aerogel coated in polydopamine for 12 hours had a bulk density of 0.13 g/cm³, and the silica aerogel coated in polydopamine for 24 hours had a bulk density of 0.13 g/cm³. The density values were not statistically different (p=0.55). Pycnometry was used to determine the changes in skeletal density among the uncoated and coated aerogels. Using the skeletal density values along with the bulk density allowed for the porosity of each sample to be calculated. The porosity for the native silica aerogel was calculated to be 92.2±0.8%, the porosity of the silica aerogel coated in polydopamine for 12 hours was calculated to be 92.6±0.9%, and the porosity of the silica aerogel coated in polydopamine for 24 hours was calculated to be 92.4±0.7%. The porosity values for the polydopamine-coated aerogels were therefore not statistically different from the native aerogel (p=0.84) indicating that the polydopamine coating has a minimal effect on porosity. Additionally, the shrinkage values for each silica aerogel were determined with the native silica aerogel having a shrinkage value of 7±1%, the silica aerogel coated in polydopamine for 12 hours having a shrinkage value of 7±2%, and the silica aerogel coated in polydopamine for 24 hours having a shrinkage value of 8±1%. The shrinkage values for the polydopamine-coated aerogels were therefor not statistically different from the native aerogel (p=0.66).

Along with high porosity, silica aerogels are known for their high surface area. Therefore, BET surface area measurements were performed on the native silica aerogels, the silica aerogel coated in polydopamine for 12 hours, and the silica aerogel coated in polydopamine for 24 hours The native silica aerogel had an average BET surface area of 642±45 m²/g, the silica aerogel coated in polydopamine for 12 hours had an average BET surface area of 614±35 m²/g, and the silica aerogel coated in polydopamine for 24 hours had an average BET surface area of 658±15 m²/g. There was therefore no significant difference in the surface areas across the different aerogel samples (p=0.34) showing that the polydopamine coating does not affect the surface area of the aerogel. This suggests that polydopamine coated the backbone of the silica aerogel as opposed to aggregating in the pores of the aerogel as a consequence of amine functional groups present along the silica backbone that aided in the polymerization of the dopamine on the surface of the silica aerogels.

To evaluate the differences in chemistry between the native silica aerogel and the polydopamine-coated silica aerogels, IR spectra were collected. The IR spectra for the native silica aerogel depicted strong peaks around 500 cm⁻¹ and 1,200 cm⁻¹, as well as some weak bands in the 3,000-3,500 cm⁻¹ region as typically observed when silica is present. When an IR spectrum is collected for a polydopamine-coated silica aerogel, similar peaks are observed as compared to the native silica aerogel due to the coating being very thin. To highlight the changes in IR spectrum, the differences or net spectrum was calculated, which showed polydopamine signatures around 1520 cm⁻¹ and 1628 cm⁻¹. The peak around 1520 cm⁻¹ is thought to be due to the carbon-carbon double bonds in the polydopamine structure, while the peak around 1628 cm⁻¹ is thought to be due to the carbonyl group in the polydopamine structure.

To demonstrate the ability of polydopamine-coated aerogels to mitigate UV radiation, the UV absorption from 300-800 nm was measured for both native silica aerogels and polydopamine-coated aerogels. The high absorbance measured for the native silica aerogels and both polydopamine-coated silica aerogels is due to absorption and due to scattering as a result of the porous structures of all three aerogels. Since the structure of the native silica aerogels and both polydopamine-coated silica aerogels are very similar, it is thought that the differences that do exist are due to absorption. In comparison, the polydopamine-coated aerogels both absorb a significantly higher amount of light below 650 nm. The transmittance below 500 nm was unable to be measured for the polydopamine-coated aerogels due to the absorbance being very high and the transmittance level being close to the detection limit of the UV spectrometer. This increased broad absorption observed for the polydopamine-coated aerogels is believed to be due to the unique ability of polydopamine to absorb UV radiation.

In light of the foregoing, it should be appreciated that the present invention significantly advances the art by providing a polydopamine-coated aerogel and a method of making the same that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

In order to demonstrate practice of the invention, the following examples are offered to illustrate the invention more fully but are not to be construed as limiting the scope thereof. Further, while some of examples may include conclusions about the way the invention may function, the inventors do not intend to be bound by those conclusions but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is number average molecular weight, temperature is in degrees Centigrade, and pressure is at or near atmospheric.

### Materials

Tetramethyl orthosilicate (TMOS, >99% purity), (3-aminopropyl)triethoxylsilane (APTES, >97%, packaged under nitrogen) was obtained from Gelest Inc. Dopamine hydrochloride was obtained from Sigma-Aldrich. Ethanol was obtained from Decon Laboratories. Ultrapure water with a resistance of 18.2 MΩ·cm was obtained from Millipore filtration system (with deionizing and organic columns). All glassware used was base bath cleaned followed by thorough rinsing with deionized water.

### Synthesis of APTES and TMOS Gel

Silica gels were prepared using the traditional sol-gel process. All gels were prepared by mixing two solutions, solution A and solution B. Combination of solutions A and B resulted in a concentration of 1.25 M silica solution with a silane molar ratio of 1:3 APTES:TMOS. As an example, solution A contained 4.3 mL of APTES, 13.8 mL of TMOS, and 34 mL of ethanol while solution B contained 11 mL of water and 34 mL of ethanol. The mixture was immediately poured into cylindrical molds. These gels were left to age for over a period of 24 hours. Afterwards, the gels were put through a series of solvent exchanges with pure ethanol to remove any unreacted monomers. Following this, the system is taken to its supercritical state to reach 78 bar and 38° C. using the multichambered automated Accudyne Industries supercritical fluid extraction system.

### Synthesis of Tetramethyl Orthosilicate (TMOS Gel)

The TMOS gels were prepared by mixing two solutions: A and B. As an example, solution A contained 9.3 mL of TMOS and 16 mL of ethanol, while solution B contained 16.5 mL of ethanol, 8 mL of water, and 1 mL of ammonium hydroxide. Combination of solutions A and B resulted in a silica concentration of 1.5 M. The gel mixture was immediately poured into cylindrical molds. The gels were left to age for over a period of 24 h. Afterwards, the gels were subjected to a series of solvent exchanges with pure ethanol to remove any unreacted monomers.

### PDA Coating of the Silica Gels

In order to encourage polymerization of dopamine, silica gels (made of TMOS and APTES) in 100% ethanol were taken through a series of solvent exchanges to achieve a 1:1 ratio of ethanol:water solution in order to encourage PDA formation. Gels were submerged gradually in solutions with increasing concentrations of water. Gels submerged in a 6:4 ethanol:water solution were allowed to sit overnight before transferring them to a 1:1 ethanol:water solution containing 1 mg/mL of dopamine hydrochloride. This solution was prepared by first dissolving dopamine into water and then adding ethanol. Within a few minutes, the gel color began to change from transparent to pale brown to dark brown, depending upon the reaction time. Gels with reaction times of 1, 2, 3, 7, 12, 21, and 24 h were prepared. However, only the gels obtained at t=12 h and t=24 h were characterized. A similar solvent exchange process was performed at the end to transfer the gels back to 100% ethanol for supercritical CO₂ extraction. Finally, the samples were dried at 60° C. using a vacuum oven overnight before characterization.

In order to demonstrate that the amine functionality on the silica backbone of the gel plays a role in getting the conformal coating of polydopamine (PDA), we coated only TMOS and TMOS/APTES gels using the procedure described above. While the TMOS/APTES gel began to change color from pale brown to dark brown within a few minutes when dipped in a 1 mg/mL dopamine solution in 1:1 ethanol:water solution, the TMOS gel showed little to no change in color even after 24 h. Clearly, the presence of APTES in the silica gel is essential for obtaining the conformal coating of PDA on the silica aerogels potentially due to interactions between the amine groups of APTES and catechol groups of dopamine.

### Characterization of Native and PDA-Coated Silica Aerogels

The mesoporous structure of native and PDA-coated silica aerogels was examined using a Hitachi S-4700 field emission scanning electron microscope (SEM). To avoid charging of samples, the samples were coated with a 5 nm layer of platinum. One sample of each coating time was analyzed using SEM. Three different images of each sample were used to quantify the pore and particle size of the aerogel monoliths. The pore size and secondary particle size of the aerogel monoliths were measured using the PCI Quartz software.

Infrared (IR) spectra were acquired for the native and PDA-coated silica aerogels using the Thermo Scientific Nicolet iS10 Fourier transform infrared spectrometer, using a single bounce germanium crystal in the attenuated total reflectance (ATR) geometry. A total of 64 scans were averaged to obtain the final IR spectrum with a resolution of 4 cm⁻¹.

Bulk density, ρb was determined by dividing the mass of the aerogel by its volume, V. The volume (V=πr2 h) was calculated by measuring the length (h) and diameter (2r) of the cylinder. The skeletal density, ρs of the native and PDA-coated silica aerogels was measured using a Micromeritics Accupyc 1340 helium pycnometer. Porosity was determined using bulk density and skeletal density measurements.

Surface area measurements were obtained using the ASAP 2020 Micromeritics System. The surface area of the native and PDA-coated aerogels was calculated at relative pressures between 0.05-0.3 atm using the Brunauer-Emmett-Teller (BET) model.

UV-Vis spectra were acquired for the native and PDA-coated silica aerogels using the Agilent Cary 60 UV-Vis spectrometer. Disk-like samples with thicknesses ranging 0.312-0.485 cm were scanned with wavelengths ranging from 300-800 nm in the transmission geometry. Aerogel samples were taped to the sample holder. Each sample was scanned a total of three times in 3 different spots on the sample. Since the different samples varied in thickness, the spectra were normalized from each sample by thickness for comparison purposes. The normalized representative spectra form each sample were given.

What is claimed is:

1. The process of coating a silica aerogel with polydopamine comprising:
a) mixing together a silica precursor and an amine-functionalized silica precursor in a solvent to form a first solution;
b) adding an acid catalyst to the first solution to form a silica gel;
c) equilibrating the silica gel in a 50/50 solvent/water mixture; and
d) adding between a 1 mg/mL and 2 mg/mL solution of a dopamine monomer to the silica gel to form a polydopamine coated aerogel.

2. The process of claim 1, wherein the silica precursor is selected from tetramethyl orthosilicate (TMOS) or tetraethyl orthosilicate (TEOS).

3. The process of claim 2, wherein the amine-functionalized silica precursor is (3-Aminopropyl)triethoxysilane (APTES) or (3-Aminopropyl)trimethoxysilane (APTMS).

4. The process of claim 3, wherein the solvent is selected from ethanol or methanol.

5. The process of claim 4, wherein the acid catalyst is selected from the group consisting of hydrochloric acid, nitric acid, sulfuric acid, oxalic acid, hydrofluoric acid, acetic acid, or water.

6. The process of claim 5, wherein the dopamine monomer is selected from the group consisting of dopamine hydrochloride, levodopa (L-DOPA), catechol, tyrosine, leucodopachrome, adrenochrome, 1,8-dihydroxynaphthalene, 5,6-dihydroxyindole-2-carboxylic acid (DHICA), 5,6-dihydroxyindole (DHI), epinephrine, norepinephrine, serotonin, tryptamine, tyramine, cysteine, selenocysteine glutamine hydroxamate (HGA), or 5-cys-dopa.

7. The process of claim 6, wherein the silica precursor is TMOS, the amine-functionalized silica precursor is APTES, the solvent is ethanol, the acid catalyst is water, and the dopamine monomer is dopamine hydrochloride.

8. The process of claim 1, further comprising the step of washing the silica gel with the solvent prior to step c).

9. The process of claim 1, further comprising the step of equilibrating the polydopamine aerogel formed in step d) in a 100% solvent solution.

10. A polydopamine coated silica aerogel comprising the reaction product of:
a) a silica gel, and
b) a dopamine monomer solution,
wherein the silica gel comprises the reaction product of
a) a silica precursor,
b) an amine-functionalized silica precursor, and
c) an acid catalyst.

11. The polydopamine coated silica aerogel of claim 10, wherein the silica precursor is tetramethyl orthosilicate (TMOS) or tetraethyl orthosilicate (TEOS).

12. The polydopamine coated silica aerogel of claim 11, wherein the amine-functionalized silica precursor is (3-Aminopropyl)triethoxysilane (APTES) or (3-Aminopropyl)trimethoxysilane (APTMS).

13. The polydopamine coated silica aerogel of claim 12, wherein the acid catalyst is selected from the group consisting of hydrochloric acid, nitric acid, sulfuric acid, oxalic acid, hydrofluoric acid, acetic acid, or water.

14. The polydopamine coated silica aerogel of claim 13, wherein the dopamine monomer is selected from the group consisting of dopamine hydrochloride, levodopa (L-DOPA), catechol, tyrosine, leucodopachrome, adrenochrome, 1,8-dihydroxynaphthalene, 5,6-dihydroxyindole-2-carboxylic acid (DHICA), 5,6-dihydroxyindole (DHI), epinephrine, norepinephrine, serotonin, tryptamine, tyramine, cysteine, selenocysteine, glutamine hydroxamate (HGA), or 5-cys-dopa.

15. The polydopamine coated silica aerogel of claim 14, wherein the silica precursor is TMOS, the amine-functionalized silica precursor is APTES, the solvent is ethanol, the acid catalyst is water, and the dopamine monomer is dopamine hydrochloride.
